(19) United States
(12) Patent Application Publication
(10) Pub. No.: US 2014/0032325 A1
(43) Pub. Date: Jan. 30, 2014

(54) SYSTEM AND METHOD FOR PROMOTING ITEMS WITHIN A LOCATION-BASED SERVICE

(71) Applicants: Noah Weiss, New York, NY (US); Jason Liszka, New York, NY (US); Simon Favreau-Lessard, San Francisco, CA (US); Dan Harrison, New York, NY (US); Tudor Leu, New York, NY (US); Tim Julien, New York, NY (US)

(72) Inventors: Noah Weiss, New York, NY (US); Jason Liszka, New York, NY (US); Simon Favreau-Lessard, San Francisco, CA (US); Dan Harrison, New York, NY (US); Tudor Leu, New York, NY (US); Tim Julien, New York, NY (US)

(21) Appl. No.: 13/949,465

(22) Filed: Jul. 24, 2013

Related U.S. Application Data
(60) Provisional application No. 61/674,986, filed on Jul. 24, 2012.
(60) Provisional application No. 61/786,879, filed on Mar. 15, 2013.

(51) Int. Cl. G06Q 30/02

(52) U.S. Cl. CPC G06Q 30/0261
USPC 705/14.58

(57) ABSTRACT

A mobile application is provided that provides promoted items within a location-based service. Advertisers or other providers are permitted to have messages displayed within the mobile interface of a user within a list (or other user-interface type) of recommendations for venues. In one implementation, one or more venues may be scored based on a number of parameters (e.g., whether the user had been to the venue previously, whether their “friends” have been at the venue, whether they have unlocked “specials” or other types at this venue previously, their nearness or proximity to the venue, time of day, etc.) and if the venue has to been determined to be displayed within a list of venues, that special may be “promoted” to the top of the list that is displayed to the user. In this way, advertisers or other providers can signal location-based users of important items located proximate to the user's location. An interface may be provided to the advertiser or other provider to define a special or other message that is to be “promoted” to a top of the displayed list. In one embodiment, a promoted special is limited to being displayed in a list of a particular search category in which it was ranked.

### RELATED APPLICATIONS

This application claims priority under 35 U.S.C. §119(e) to U.S. Provisional Patent Application Ser. No. 61/674,986, entitled “SYSTEM AND METHOD FOR PROMOTING ITEMS WITHIN A LOCATION-BASED SERVICE,” filed on Jul. 24, 2012, of which application is herein incorporated by reference in its entirety. This application claims priority under 35 U.S.C. §119(e) to U.S. Provisional Patent Application Ser. No. 61/786,879, entitled “SYSTEM AND METHOD FOR PROMOTING ITEMS WITHIN A LOCATION-BASED SERVICE,” filed on Mar. 15, 2013, of which application is herein incorporated by reference in its entirety.

### BACKGROUND

There are many location-based systems in use today. In particular, location-based services such as the Foursquare system (available on the Internet at http://www.foursquare.com) permit users to verify their locations using one or more computer systems. Some services permit users to use their locations for the purpose of interacting within a social network. For instance, within one type of location-based social network, users are permitted to perform a “check-in” to particular locations, including venues such as businesses, retail locations, points of interest, or other locations. A check-in generally includes a process that identifies a user with a particular venue location at a given time, and such check-ins may be recorded over time (e.g., by a location-based social network). Such location-based social networks also permit users to interact with friends, find venues of interest, leave comments regarding particular venues, among other functions.

### SUMMARY

Aspects of the present invention relate generally to advertising and specials. In one aspect, a location-based system may be provided that allows users to locate one or more venues based on location, as well as other information (e.g., recommendations by others, where people having similar tastes have been, what is popular, etc.). In one embodiment, such recommendations may be displayed to a user operating a mobile device, such as a cell phone. The mobile device may request (e.g., from a server), a list of recommendations in one or more categories based on the device's location.

In one embodiment, advertisers or other providers are permitted to have messages displayed within the mobile interface of a user within a list or other user-interface construct that shows recommendations for venues. In one implementation, one or more venues may be scored based on a number of parameters (e.g., whether the user had been to the venue previously, whether their “friends” have been at the venue, whether they have unlocked “specials” or other types at this venue previously, their nearness or proximity to the venue, to time of day, etc.) and if the venue has been determined to be displayed within a list of venues, that special, advertisement, message, venue, or other item may be “promoted” to the top of the list that is displayed to the user. In this way, advertisers or other providers can signal location-based users of important items located proximate to the user's location.

To this end, an interface may be provided to the advertiser or other provider to define a special or other message that is to be “promoted” to a top of the displayed list. In one embodiment, a promoted special is limited to being displayed in a list of a particular search category in which it was ranked (e.g., Food). Due to display considerations on a mobile device, only one or a limited number of these promoted specials may be displayed to a user in response to the user entering a query or otherwise exploring venues to be searched. In one implementation, only one promoted item is selected. In another implementation, if there are two or more promoted specials that could possibly be chosen based on a particular category or search criteria (including, for instance, location of the mobile device), then only one promoted special may be chosen for display. Selection may be performed, for instance, based on the score determined for the particular venue (e.g., as discussed above).

Further, although tools may be provided to merchants and venue owners to create and manage venues, specials, offers, and promoted items, a programmatic method is provided for permitting third party sources to provide content that can be promoted within a location-based service. For instance, a third party source of offers may be accessed by a location-based service, and offers for venues defined within the location-based service may be imported to the location-based service (e.g., as a “special,” offer, event, sale or other location-based item). One or more of these imported items may be tagged as a promoted item.

In another embodiment, a user may explore items by location (e.g., using a map) and according to one embodiment, promoted items may be displayed within the interface based on their location in relation to a location. For instance, a user may operate a map interface that shows the user's present location (e.g., as determined by the user's mobile device), and one or more promoted items may be indicated to the user if the promoted items have an associated location that is within a certain range (e.g., within the displayed map area, within a predefined distance from the user's location, within a particular locale (e.g., San Francisco) or other location-based criteria). Such items may be displayed more prominently on the map or other notifications of the promoted items may be displayed to the user.

According to one embodiment, some promoted items such as ads, messages, or other promoted item types may be associated with a specific venue. According to another embodiment, other types may be associated with a geographic area. For instance, in one aspect of the present invention, a location-based system may use an adjustable boundary of a geographical area in which to trigger a display of promoted items to a particular user responsive to an action performed by a user in a location-based service (e.g., moving to a location, checking in to a venue, searching for venues, or other action). Further, according to one aspect, merchants and other venue owners may be provided a capability of targeting users within particular geographic areas.

In one embodiment, the geographic area may be determined by a user (e.g., located within 1 mile of a particular venue, within the San Francisco area, within 200 feet of any store of the chain, etc.). According to one embodiment, the boundary of search may be adjusted based on the density of venues within a particular area. For instance, from a particular geographic point, a radius from the geographic point may be adjusted to achieve a particular venue density within a circular area. Although a circle may be used, other boundary types and shapes may be used (e.g., square, rectangle, displayed map area, town, or similar boundary).

Interfaces may also be provided to allow advertisers to “bid” for placement as a promoted item within a list of recommendations. In one implementation, the winning item may be displayed at or near the top of a list of recommendations (e.g., based at least in part on the location of the user/mobile device). To this end, an interface that permits a promoted item that is associated with a bid to be provided to a location-based service. In one embodiment, bidding may be combined with other processes to determine a winning item. For instance, a calculation of predicted conversion rate, relevance score, or other method of ranking a listing may be used in combination with a bid result to determine what promoted item is displayed to a particular user.

According to one aspect of the present invention, it may be beneficial to provide a dashboard or other interface type to allow merchants, venues, and other managing entities within a location-based service to promote items created within the service. For instance, venues, offers, specials, or other items created within the location-based service may be easily tagged as a promoted item. As a result, visibility of the item on a list of recommended items (e.g., in a location-based application interface) may be increased. Further, a facility may be provided for merchants, venue owners, and other entities to broadcast messages to particular users. For instance, based on a location of a user within the location-based system, the user may be sent one or more broadcast messages. For example, in one implementation, a user having a device within a certain distance radius of a venue may be targeted for a particular broadcast message. In another implementation, a venue owner may simply desire to promote their venue, and their venue may be tagged as a promoted item in the location-based service.

It is also appreciated that there is a need to provide more accurate and relevant recommendations and/or promoted items by a location-based service (e.g., within a ranked list where recommendations and promoted items may be displayed). In one aspect of the present invention, it is desired that a mobile application be provided that provides intelligent recommendations based on the knowledge of where the user has been, and where the user would like to go. Further, such an application may be capable of determining where your friends have been and where they would like to go. Also, in another implementation, the application may be capable of determining where people with similar tastes have been, and where they would like to go. Some or all of this information may be used by a mobile application that provides recommendations to a user. For instance, in one implementation, a user having a mobile device such as a cell phone wishes to locate a venue (e.g., a restaurant or other business) based on one or more parameters, and some or all of this information may be used to order or rank recommendations within the interface of the mobile device.

It may be useful and particularly advantageous to provide recommendations using location-based services. Although locating venues based on location of a user using location-based services is known, it would be beneficial to provide higher quality recommendations to users (e.g., potential customers) using a location-based service. It is appreciated that the user benefits by having higher quality recommendations provided, and will therefore be more likely to use the location-based service. Further, because the quality of recommendations, according to one embodiment, are driven by the user interacting with the location-based service, the user will be more likely to interact with the location-based service in the future.

According to one embodiment, information associated with the user is used to determine recommendations and/or promoted items. In one example, venue locations where the user has previously visited may influence what recommendations and/or promoted items may be listed for a user. For instance, a location-based service may store information for each particular user, including preference information identifying preferences of particular venues the user has visited (e.g., “tips”). Further, the location-based service may store preferences for venues that the user has not yet visited (e.g., “to do” information).

In another embodiment, information associated with other users in the location-based system may be used to provide recommendations and/or promoted items to a user. For instance, for users that are the current users “friends,” information regarding what venues those users have visited, their preferences for particular venues, and preferences for venues that they have not visited may be used to influence what recommendations and/or promoted items may be displayed to the current user. Other users not in the current user's network may also be used to determine what recommendations and/or promoted items are displayed. For instance, certain recommendations and/or promoted items may be determined as more popular and/or have higher quality ratings as determined by other users, specific groups of users, or the entire network itself.

A user interface may be provided that allows a user to more quickly locate desired venues. Also, because interfaces on mobile devices can display limited results, it is appreciated that the quality of recommendations and/or promoted items within the display is important. According to one embodiment, the number of promoted items may be limited to reduce the effect of ad placements to the overall usability of the location-based service. For instance, in one embodiment, only one or two promoted items may be displayed at one time.

An interface, according to one embodiment, may include an ordered list of recommendations (e.g., responsive to a query including one or more parameters such as keywords, distance, category, etc.), and this list of recommendations may be ordered based on one or more of the information items described above. According to one embodiment, the list may be adjusted according to personal information (e.g., information recorded regarding the current user's preferences and/or history), social network information (e.g., information recorded regarding the current user's friends), and/or popularity of the items themselves (e.g., as determined by group(s) of users and/or the entire network). Promoted items may be adjusted in a similar manner. Further, as discussed above, a limited number of promoted items may be displayed along with an ordered list of recommendations.

According to one embodiment, a search engine associated with a location-based service may provide recommendation and/or promoted item information based on one or more inputs provided by a user (e.g., via an interface of a mobile device). For instance, a user may be located at a particular location and that user decides he/she would like to purchase food. That user may also provide more specific information (e.g., the keyword “that”) although the user to could be less specific and just specify a category such as “food.” In one implementation, the user may select a control on the mobile device (e.g., a button) that specifies the category “food” or lists a number of categories of interest (e.g., in a menu structure). In the example above, the user may not want to travel past a certain distance, so the interface may permit the user to enter a distance limitation to the search along with the user's current location. The search engine may use any parameters provided by the user and the system (e.g., location of the user in latitude/longitude, altitude, etc.) to determine a list of recommendations and/or promoted items.

According to one embodiment, a ranking component may use the query results to determine a ranking of the venue locations based on one or more elements. For instance, for every venue that satisfies the original search criteria, a score may be determined based on one or more parameters. As discussed above, the list may be adjusted according to personal information, social network information, and/or popularity of the items themselves.

In one example implementation, a ranking may be provided that evaluates a particular venue (e.g., one that was returned from the query results), evaluate every venue the user has been within the location-based service (e.g., locations in which the user has “checked in”) and approximate the user's rating for that particular venue. According to one embodiment, venue information may be scored using one or more functions that determine the user's preference for a particular venue. For instance, collaborative filtering functions, item-item correlation, k-nearest neighbors, or other functions may be used to determine a user's preference. Generally, such functions have been used to predict a user's affinity for certain products (e.g., movies, web pages, consumer products). However, it is appreciated that venue preferences may be predicted using such functions in a location-based service based on where the user has previously been, preferences of people in their social network, and/or preferences of the certain groups or the entire network of location-based service users. Such information may be used to rank and/or display promoted items.

In one example, for each venue, a system is provided that evaluates every venue (e.g., meeting the query criteria provided) where the user has previously been and approximates the user's rating of each venue using one or more functions (e.g., collaborative filtering, item-item, k-nearest neighbors, etc.). For each venue, the system may also determine if people in the user's social network (e.g., friends) have been to the venue, if so, the system may provide an approximation of the user's rating based on how much the user's social network rated the venue, visited the venue, or had an effect on any other parameter or combination thereof relating to the venue (e.g., as determined via collaborative filtering, user-user, k-nearest neighbors functions). Further, the system may determine, as a baseline measurement, how popular this particular venue is within the location-based system. These measurements may be adjusted by other factors (e.g., the probability that a user will perform a “check-in” at this venue at a particular time of day, day of week, etc.).

In one specific implementation, each venue may have multiple scores associated with it, two approximations based on functions, baseline popularity as discussed above, and additional information such as preference information for venues already visited (e.g., “tips” to other users), preferences for venues that the user has not yet visited (e.g., “to do” information), and “likes” or other preferential indicators for a particular venue. These scores may be added up for each venue (or other location-based service item), and the score may be adjusted for other factors (e.g., adjusted by the probability that the venue is open or being frequented now) and a per venue score may be determined The output list of venues based on the original query may be ranked in the order of these final venue scores. A predetermined number of top scores may be provided to the user as recommendations. Such a list may be displayed within an interface of a mobile device associated with the user. Further, any justifications for particular rankings of recommendations and/or promoted item may be provided to the user within the interface (e.g., “Your friend John recommended this restaurant.”) to permit the user to make a more informed choice of venue or other item.

According to another aspect, it is appreciated that a location-based service may assist with providing recommendations and/or promoted items to a user. For instance, a location-based service may be used to store and manage recommendations and/or promoted items for venue locations. Such recommendation and/or promoted item information may be provided directly to users or one or more third party applications and/or systems. In one embodiment, a programmatic interface may be provided that allows third party applications to receive recommendations and/or promoted items from the location-based service. Similarly, the location-based service may import items from third parties using programmatic interfaces.

According to another aspect, it is appreciated that higher quality venues are desired for presentation to users. In one embodiment, it is appreciated that higher quality venues are contained by more lists of venues of more influential users of the location-based service than “average” venues. In one embodiment of a location-based service, users may be permitted to create one or more lists of venues that can be shared with other users. As discussed, it is desired that a signal indicative of the best venues would be helpful in the creation and display of a list to a user (e.g., particularly one of a location-based service that has limited display capability and/or needs to provide a limited number of recommendations). Thus, a method of ranking may be desired that provides a high-precision ranking of the “best” venues, but not necessarily a ranking of all venues, which might be typically returned in an Internet search.

To this end, it is appreciated that users of the location-based service that “follow” one or more lists of venues (e.g., in a particular geographic area, venue type, category of venue, or other parameter used to group venues) may provide better signals of what venues should be more highly ranked. For instance, a score or other type of ranking may be determined for a venue that determines how popular that venue is with “experts” in a particular category or other grouping of venues. In another example, a score or other type of ranking may be determined for a venue that identifies the number and/or quality of lists that contain this venue. For instance, the number of lists in which a venue appears may be determined and may be indicative of how good a venue is.

Also, in another example, there may be comparative rankings of lists that can be used to determine a ranking of a particular venue that is associated with the list. For instance, if a particular venue is highly ranked on a popular list, that venue may be ranked or scored relative to the list's popularity. In yet another example, tips associated with each venue that are left by users may be analyzed and scored for each venue. In one example, text associated with the tips themselves may be analyzed for particular keywords and scored depending on the types and number of keywords present. One advantage associated with some of these types of rankings discussed above is that they may be based on the analysis of users in general and are not dependent on one user's ranking or preferences. For instance, it may be beneficial in a location-based system to aggregate the responses of multiple users into a score for a particular venue, and that score may be used to rank venues within a recommendation interface presented to other users. Such a score may be determined using one or more of the scores determined based on any of the score types discussed above.

According to another aspect of the present invention, a location-based system may determine an adjustable boundary of a geographical area in which to search for venues based on a query (e.g., a query provided by a user within an interface of a mobile device). According to one embodiment, the boundary of search may be adjusted based on the density of venues within a particular area. For instance, from a particular geographic point, a radius from the geographic point may be adjusted to achieve a particular venue density within a circular area. Although a circle may be used, other boundary types and shapes may be used (e.g., square, rectangle, displayed map area, town, or similar boundary).

In another embodiment, the adjustable boundary may be determined based on a distance between subsequent “check-ins” in an area performed by users in that particular area in relation to some time. For instance, a determination may be made by the location-based system that a user checked in a certain distance from one check-in point (e.g., a first venue) to a second check-in point (e.g., a second venue). In one implementation, an average distance between check-ins (e.g., performed by one user, all users) may be used as an input to determine an adjustment of an adjustable boundary used for executing a search query for venue locations. According to one aspect, it is appreciated that the check-in history may be used as an indicator of the activity density within a particular region. In one implementation, check-in history may be used to determine a default or adjustable setting for performing a search query (e.g., as a setting in a location-based application operated by a user).

According to another aspect, it is appreciated that a time between check-ins performed with a particular venue or a time between check-ins performed by a particular user may be used by a location-based service to determine rankings of one or more venue locations. For instance, if two check-ins to a particular venue occur weeks apart, this sequence is less relevant than two check-ins that occur an hour or two apart. Further, in another example, time between check-ins may be used as a parameter to determine check-in density, which could be also used to determine an adjustable boundary for venue search.

According to one aspect, a method for presenting information to a user by a location-based system is provided. The method comprises acts of displaying, on a mobile device, a plurality of search categories for locating one or more of a plurality of venues, accepting a user selection of at least one of the plurality of search categories, determining a ranking of at least a portion of the plurality of venues for display in a display of the mobile device, the display being associated with the user selected search category, displaying the ranking of the at least a portion of the plurality of venues in the display, creating at least one promoted item associated with at least one of the plurality of venues, and displaying in the display of the mobile device the at least one promoted item within the ranking of the at least a portion of the plurality of to venues in the display.

In one embodiment, the act of displaying in the display of the mobile device the at least one promoted item includes displaying the at least one promoted item at a top of a ranked list of the at least a portion of the plurality of venues. In another embodiment, the act of displaying in the display of the mobile device the at least one promoted item includes displaying the at least one promoted item only within a particular designated category. In another embodiment, the act of displaying in the display of the mobile device the at least one promoted item includes an act of displaying the at least one promoted item responsive to location of a mobile device in relation to a location of the at least one promoted item. In another embodiment, the at least one promoted item includes a venue defined within the location-based system.

In one embodiment, the act of determining a ranking of the at least a portion of the plurality of venues for display in a display of the mobile device is responsive to an act of determining a location of the mobile device in relation to the respective locations of the at least a portion of the plurality of venues. In another embodiment, the act of determining a ranking of one of the at least a portion of the plurality of venues is based on a distance of the mobile device to the one of the at least a portion of the plurality of venues. In another embodiment, the location-based system accepts at least one bid on a placement of the at least one promoted item from a venue operator associated with a venue of the at least one promoted item.

According to one aspect, a system for presenting information to a user by a location-based system is provided. The system comprises a display, the display being adapted to display a plurality of search categories for locating one or more of a plurality of venues, an interface defined within the display configured to accept a user selection of at least one of the plurality of search categories, a processor that is adapted to determine a ranking of at least a portion of the plurality of venues for display in the display, the display being associated with the user selected search category, wherein the display is adapted to display the ranking of the at least a portion of the plurality of venues; and an interface configured to create at least one promoted item associated with at least one of the plurality of venues, wherein the display is configured to display the at least one promoted item within the ranking of the at least a portion of the plurality of venues.

In one embodiment, the display is configured to display the at least one promoted item at a top of a ranked list of the at least a portion of the plurality of venues. In another embodiment, the display is configured to display the at least one promoted item only within a particular designated category. In another embodiment, the display is configured to display the at least one promoted item responsive to location of a mobile device in relation to a location of the at least one promoted item.

In one embodiment, the at least one promoted item includes a venue defined within the location-based system. In another embodiment, the processor that is adapted to determine the ranking of the at least a portion of the plurality of venues for display in the display is responsive to a component that is adapted to determine a location of the mobile device in relation to the respective locations of the at least a portion of the plurality of venues. In another embodiment, the processor that is adapted to determine the ranking of the at least a portion of the plurality of venues for display in the display is responsive to a distance of the mobile device to the one of the at least a portion of the plurality of venues. In another embodiment, the location-based system accepts at least one bid on a placement of the at least one promoted item from a venue operator associated with a venue of the at least one promoted item.

According to one aspect, a method for processing venue information in a location-based system is provided. The method comprises acts of creating, by an advertiser, an item to be promoted in a list of recommended venues, storing the item to be promoted in a location-based system; determining one or more user-related parameters, scoring a plurality of venues based the determined one or more user-related parameters, determining a list of recommended venues to display, and displaying the list of recommended venues to display including the promoted item.

In one embodiment, the one or more user-related parameters include a determined location of the user. In another embodiment, the act of displaying the list of recommended venues to display including the promoted item includes displaying the promoted item at a top of a ranked list of the list of recommended venues. In another embodiment, the act of displaying the list of recommended venues to display including the promoted item includes displaying the promoted item only within a particular designated category. In one embodiment, the act of scoring the plurality of venues based the determined one or more user-related parameters is responsive to a location of a mobile device in relation to a location of the at least one promoted item.

In one embodiment, the promoted item includes a venue defined within the location-based system. In another embodiment, the act of displaying the list of recommended venues to display including the promoted item is responsive to an act of determining a location of a mobile device in relation to the respective locations of the at least a portion of the plurality of venues. In another embodiment, the method further comprises an act of determining a ranking of one of the at least a portion of the plurality of venues based on a distance of the mobile device to the one of the at least a portion of the plurality of venues. In another embodiment, the method further comprises an act of accepting at least one bid on a placement of the promoted item from a venue operator associated with a venue of the promoted item. In another embodiment, the promoted item is at least one of a group comprising a venue, an advertisement, a special, an offer, a message, and a location-based service item. In one embodiment, the promoted item is at least one of a group comprising a venue, an advertisement, a special, an offer, a message, and a location-based service item.

According to one aspect, a method for processing venue information in a location-based system is provided. The method comprises acts of creating, by an advertiser, an item to be promoted in a list of recommended venues; storing the item to be promoted in a location-based system, determining activity of a user in relation to the location-based system, and displaying the promoted item to the user responsive to the determined activity. In one embodiment, the act of determining activity of a user further comprises an act of determining a location of the user, and responsive to the determined location of the user, performing the act of displaying the promoted item to the user. In another embodiment, the method further comprises an act of associating, with the item to be promoted, a geographic location, and wherein the act of displaying the promoted item to the user is responsive to an act of determining if the user is located at or near the geographic location.

Still other aspects, examples, and advantages of these exemplary aspects and examples, are discussed in detail below. Moreover, it is to be understood that both the foregoing information and the following detailed description are merely illustrative examples of various aspects and examples, and are intended to provide an overview or framework for understanding the nature and character of the claimed aspects and examples. Any example disclosed herein may be combined with any other example in any manner consistent with at least one of the objects, aims, and needs disclosed herein, and references to “an example,” “some examples,” “an alternate example,” “various examples,” “one example,” “at least one example,” “this and other examples” or the like are not necessarily mutually exclusive and are intended to indicate that a particular feature, structure, or characteristic described in connection with the example may be included in at least one example. The appearances of such terms herein are not necessarily all referring to the same example.

### BRIEF DESCRIPTION OF THE DRAWINGS

Various aspects of at least one example are discussed below with reference to the accompanying figures, which are not intended to be drawn to scale. The figures are included to provide an illustration and a further understanding of the various aspects and examples, and are incorporated in and constitute a part of this specification, but are not intended as a definition of the limits of a particular example. The drawings, together with the remainder of the specification, serve to explain principles and operations of the described and claimed aspects and examples. In the figures, each identical or nearly identical component that is illustrated in various figures is represented by a like numeral. For purposes of clarity, not every component may be labeled in every figure. In the figures:

FIG. 1 is a block diagram showing a location-based service and system suitable for incorporating various aspects of the present invention;

FIG. 2 shows a block diagram of a distributed system suitable for performing various aspects of the present invention;

FIG. 3 is a block diagram showing an example process for providing promoted items and recommendations in a system that uses location-based services;

FIGS. 4A-4C show example interfaces according to various embodiments of the present invention;

FIG. 5 is a block diagram showing an example process for providing recommendations in a system that uses location-based services;

FIG. 6 is a block diagram showing an example process for scoring venue locations using a location-based service according to one embodiment of the present invention;

FIG. 7 shows an example interface in which recommendations may be provided according to one embodiment of the present invention;

FIG. 8 shows an example interface within a particular venue category according to one embodiment of the present invention;

FIG. 9 shows an example computer system with which various aspects of the invention may be practiced; and

FIG. 10 shows an example storage system capable of implementing various aspects of the present invention.

### DETAILED DESCRIPTION

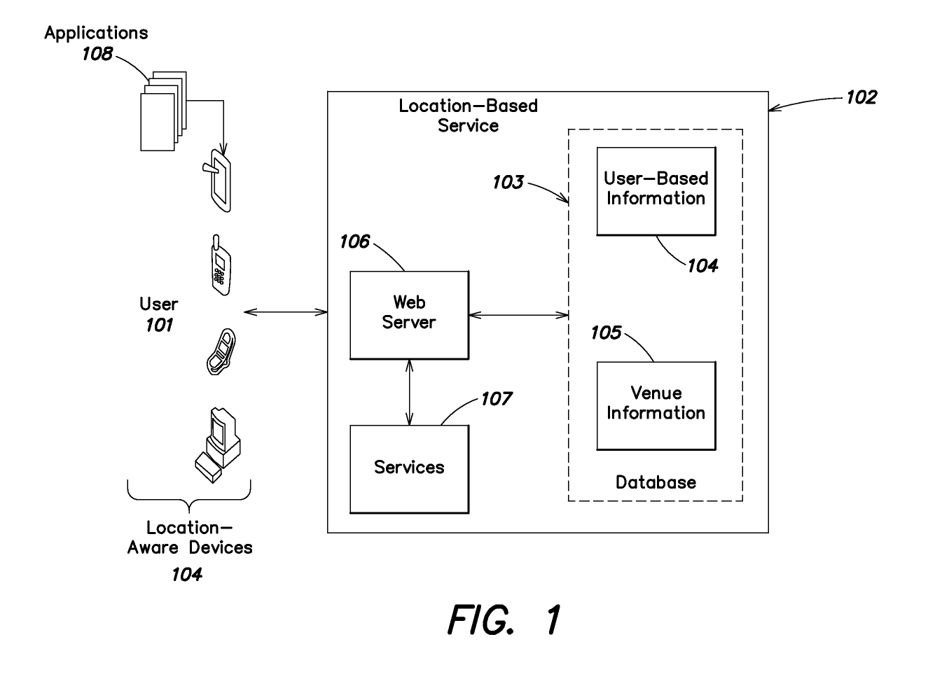

FIG. 1 shows a block diagram of a location-based service and system suitable for incorporating various aspects of the present invention. For instance, a location-based service 102 may permit one or more users (e.g., user 101) to interact with one or more other users, systems and services based on their location. To this end, the user's location may be determined using one or more location-aware devices (e.g., devices 104), such as, for example, a cell phone, smart phone, PDA, tablet computer, laptop or other system.

The location-based service may provide one or more recommendations for the user based on their location. Further, as discussed above, the location-based service may provide one or more promoted items to the user. As discussed, promoted items may include specials, advertisements, messages, venues, or other location-based service items. Users may use an interface of the location-aware device for interacting with the system to receive recommendations and/or promoted items relating to certain venue locations or to particular geographic locations and/or areas as discussed above. These recommendations and/or promoted items may be provided responsive to one or more inputs a user might provide within the interface of the mobile device, such as a query formed by one or more keywords, selection of particular search categories (e.g., “Food”, “Nightlife”, etc.), distance from the user's current location, or other parameters, either alone or in any combination. Also, according to one embodiment, one or more promoted items may be displayed along with any provided recommendations.

In one embodiment, service 102 may include one or more components. Such components may be implemented using one or more computer systems. In one embodiment, location based service 102 may be implemented on a distributed computer system using one or more communication networks (e.g., the Internet). In one implementation, the service is implemented in a cloud-based computing platform, such as the well-known EC2 platform available commercially from Amazon.com, Seattle, Wash. In another implementation, components may be distributed throughout one or more networks or combinations of networks, may be virtualized in one or more systems, may be self-hosted and/or may be distributed among different locations (e.g., located among a number of co-location facilities). Other implementations are possible and are within the scope and spirit of the invention, and it is appreciated that other platforms or combinations thereof may be used.

Service 102 may include a web server 106 which is capable of serving as a front end to the location-based service 102. Devices may communicate and display data provided by service 106 to the user (e.g., user 101). Notably, devices may include controls that perform various functions in a location-based application (such as one or more of application(s) 108), such as viewing venues proximate to the user's location, reviewing information regarding proximate venues left by other users, communicating with other users, among other functions. Further, such devices may provide the location of the user to the location-based service 102, and this location information may be used to perform one or more functions.

Service 102 may also provide one or more related services (e.g., services 107), such as a service for recommending venues, storing pictures based on location, location-based games, or other service that utilizes location information relating to its users. Services 107 may be integral to location-based service 102 or many alternatively operate in conjunction with location-based service 102, (e.g., by communicating with the location-based service through an Application Programming Interface (API)). Notably, according to one aspect of the present invention, recommendations for particular venue locations defined within service 102 may be provided to a user.

Service 102 may also be capable of storing information in one or more databases (e.g., database 103). For instance, service 102 may be configured to store user-based information (e.g., user-based information 104) such as a user identification, identifications of friends associated with the user identification, any history information such as locations visited, preference information for particular venue locations, notes regarding venue locations visited, among other user-related information. Service 102 may also be capable of storing venue information (e.g., venue information 105) that may include, for example, location information (e.g., address, latitude, longitude, altitude, etc.), contact information, venue description, among other information. Venue information may also include, according to one embodiment, preference information for the particular venue. Other databases types may be used to store other information relating to other location-based item types (e.g., pages associated with brands/advertisers) and users' associated preferences associated with such items.

One commercially-available system that may be suitable for implementing various aspects of the present invention may include the Foursquare service, available at http://www.foursquare.com and provided by Foursquare Labs, Inc., New York. Other systems capable of providing location-based services are available and are capable of implementing various aspects of the present invention.

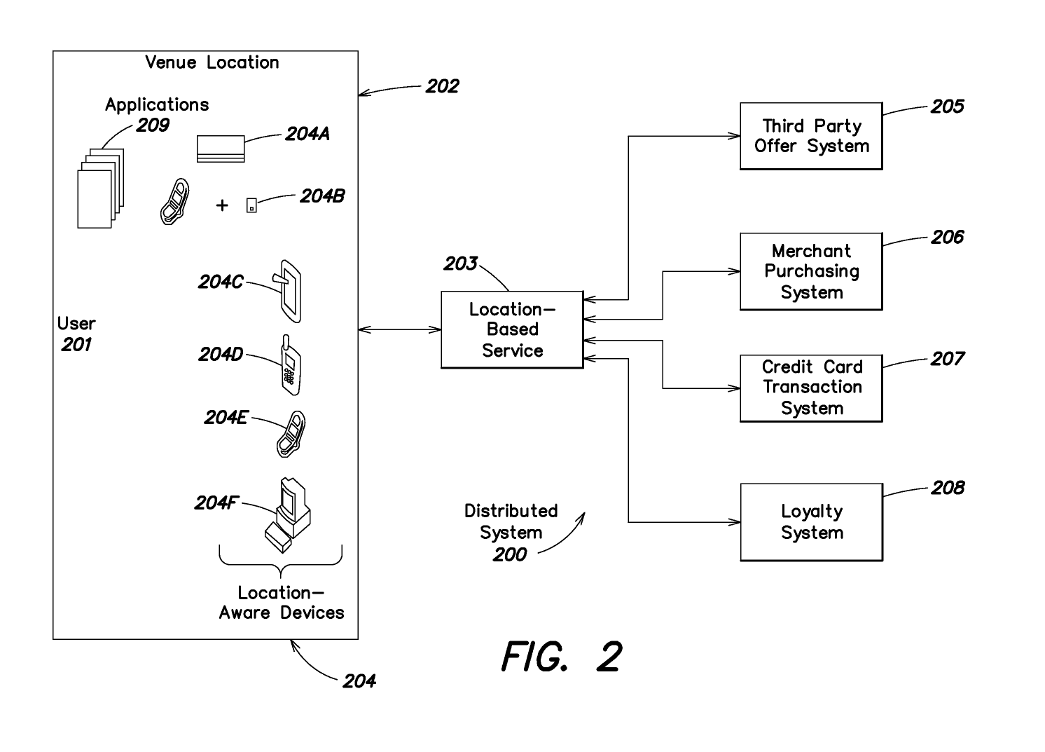

FIG. 2 shows a system incorporating various aspects of the present invention. In particular, a distributed computer system (e.g., system 200) may be provided that is capable of providing recommendations and promoted items in association with a location-based system (e.g., system 203). Such recommendations, promoted items, and other location-based items may be provided to one or more users. Further, such recommendations and promoted items may be provided to other systems and/or applications that work integrally with location-based service 203. For instance, a third party system (e.g., system 205) may be capable of receiving recommendations and/or promoted items for one or more venue locations from the location-based system.

Such recommendations and promoted items may be presented to users (e.g., user 201) at or near one or more venue locations (e.g., venue location 202) on one or more location-aware devices (e.g., device 204). For instance, recommendations may be presented and viewed using one or more applications 206 that execute on a location-aware device. Device 204 may be any device, system, or item that can be used to locate a user, including a tablet computer (element 204A), smartphone (element 204B), cell phone (204C), personal computer (element 204D), or other system type.

Location-based service 203 may include, for example, a search engine 211 that receives search information from one or more applications 206, and provides recommendations to a location-aware device for display to the user. One or more promoted items relating to the search results may be provided with the recommendations. Search engine 211 may be capable of accepting one or more parameters such as keywords, distance settings, among others, from the location-aware device and provide a list of venues that satisfy the provided parameters. Search engine 211 or any other separate process or element may be capable of ordering and/or ranking the search results based on one or more sets of information stored in a database of the location-based service.

For instance, a database 207 may be provided (either separate or the same as database 203) that stores user preference information (e.g., information 208) relating to venues stored by the location-based service. Such information may include, for example, a history of venues the user has previously visited and their rating of such venues. User preference information may also include preference information for venues that the user has not yet visited. Database 207 may also store social network preference information (e.g., information 209) relating to venues stored by the location-based service. For instance, for users defined within the location-based service or are defined in other social networking applications that are indicated as the current users “friends,” information regarding what venues those users have visited, their preferences for particular venues, and preferences for venues that they have not visited may be used to influence what recommendations may be displayed to the current user.

Database 207 may also store one or more promoted items associated with the location-based service. For instance, according to one embodiment, the location-based system may include, with an item created within the system, an indication that the item is a promoted item, and any information associated with that item. The promoted item, when matched to a particular query, triggered as a result of the users' location or action within the location-based service application, or as a result of other display criteria, may cause the item to be displayed within the interface of the location-based service application. The interface may display any information relating to the location-based item, including, but not limited to text-based messages, photo(s), special or other offer information, or any combination of information. The promoted item (e.g., an advertisement) may also allow a user to link to another page in the service or to another service.

Further, database 207 may store popularity information (e.g., information 210) relating to venues defined in the location-based service. For instance, other users not within the current user's social network may also be used to determine what recommendations and/or promoted items are displayed. For instance, certain venues or items may be determined as more popular and/or have higher quality ratings as determined by other users, specific groups of users, or the entire network itself.

In one embodiment, the user is permitted to search for recommendations within the location-based service or have promoted items displayed to the user (e.g., with an interface of a mobile device). Such recommendations may be ordered relative to a location of the venue where the user “checked in” or where the user is otherwise located. For example, as discussed above, a user's location may be determined by a location-aware device.

In one embodiment, the user “checks-in” to the location-based service using an application executing on the mobile device, and responsive to the user “checking-in,” that user is presented with one or more promoted items (e.g., advertisements). In certain embodiments, the user may be permitted to check in using a number of different applications (e.g., Check-in4Me, 4squareSMS, Foursquare, etc.) into the same location-based service or from another location-based service that shares location and check-in information regarding users. In one implementation, application providers may be permitted to receive recommendations and/or promoted items from the location-based service for display to their users. Some applications that do not provide check-in services may still be capable of receiving recommendation information and/or promoted item information from the location-based service, and display of such items may still be responsive to a check-in performed in a location-based service (e.g., a display of an advertisement in an application responsive to a check-in performed in the location-based service).

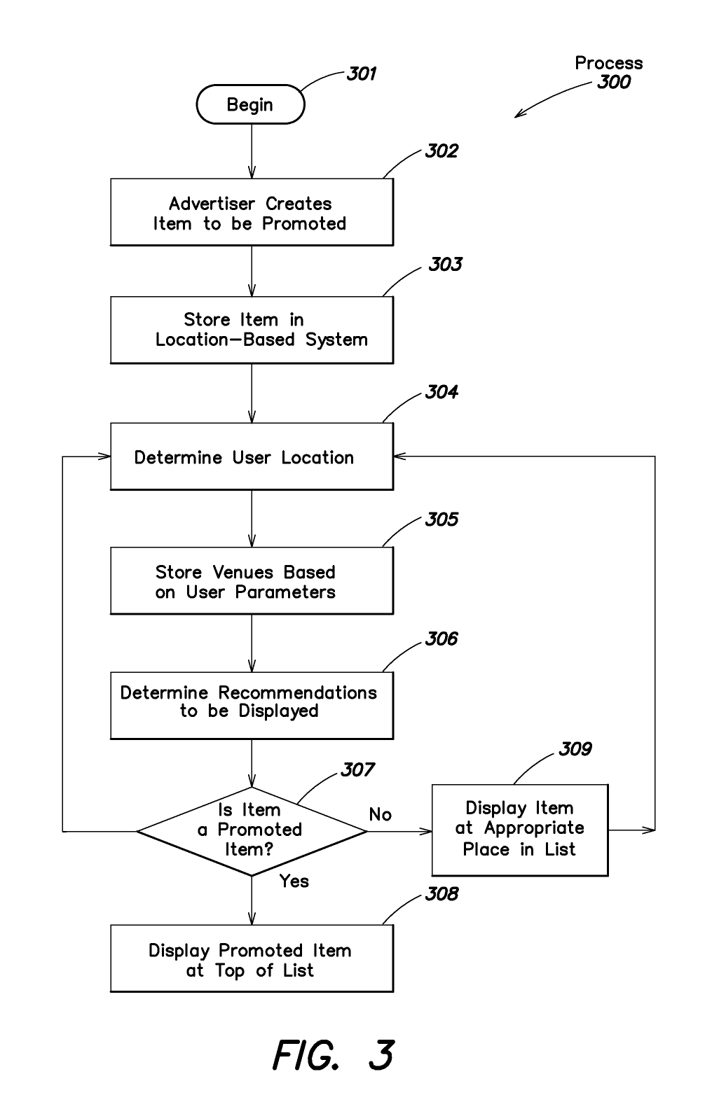

FIG. 3 shows a process 300 for promoting items within a list of recommendations. At block 300, process 301 begins. At block 302, an advertiser or other user may create an item to be promoted within a list of recommendations according to one embodiment of the present invention. For instance, such an item may include a message, an offer, or other item to be displayed. The message may include an identifier for the item as well as any associated text, images, or other information. The item may be in association with a particular venue, which has a defined location.

At block 303, the item is stored in association with a location-based system. For instance, the item may be a defined item within a location-based system, such as a special defined in the location-based system provided by Foursquare Labs, Inc. at http://www.foursquare.com. It should be appreciated that other location-based systems may be used. Such information may be stored within a database (e.g., database 207) associated with the location-based service.

At block 304, a location of the user may be determined (e.g., using a GPS and/or other location determining capability within a mobile device). In one embodiment, a number of recommendations or other items may be determined and displayed to the user that are proximate or near to the user's determined location. For instance, location-based items may be displayed that are within a redefined radius of the user's location. In one example implementation, scores may be determined for items based on one or more user-specific parameters, including location. At block 105, venues or other items may be scored based on one or more parameters. Based on the scores, the system may determine one or more recommendations to be displayed to the user in a display of the user device at block 306.

At block 307, it is determined whether the item is a promoted item. For instance, there may be an indicator that is stored by the location-based service that identifies the item as a promoted item. In one embodiment, there may be a bid or other auction type that determines, for each available opportunity to display to some user, a promoted item. If the bid amount (e.g., a not-to-exceed bid) is more than other available promoted items, that promoted item may be displayed to the user. In another embodiment, the promoted item with the highest score is displayed. In yet another embodiment, bid amount in combination with score may be used. Thus, according to one embodiment, a promoted item may be displayed to a user operating within a location-based service satisfies one or more parameters that would cause a promoted item to be displayed (e.g., is located near a venue, performs an action in the location-based service application, etc.).

If the promoted item is determined to be displayed at block 307, then, according to one embodiment, the display of that item is displayed at the top of the list or in a prominent location within the display at block 308. If not, the item may be displayed at their appropriate display in the list at block 309. The display and scoring of items may occur indefinitely as the user moves to different locations and receives different recommendations. In another embodiment, items may be promoted and/or defined in real time in the location-based system and promoted and displayed accordingly.

A promotion component associated with the location-based service determines where to rank the promoted venue, and returns a message for a client to render within the interface of the location-based application (e.g., a broadcast message, an indication of a special, etc.). For instance, a process, server, or other component of the location-based system may perform ranking of promoted items and determinations of promoted item(s) to show based on contextual determination of the user within the location-based service.

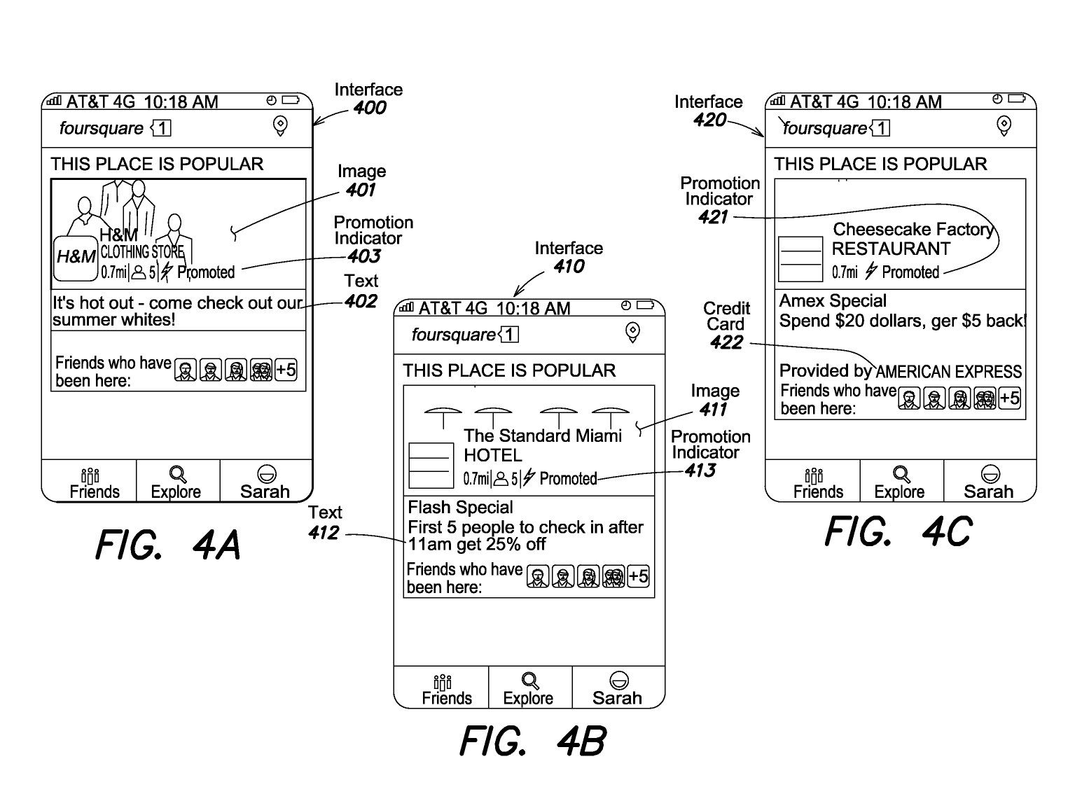

FIGS. 4A-4C show examples of promoted items and interface elements according to various embodiments of the present invention. For instance, as shown in FIG. 4A, an interface 400 may be provided that is displayed within a display of a location-based service application. For instance, the promoted item may include a venue where the promoted item may be running. For instance, the merchant may be permitted to create the promoted item for an entire chain of venues, a venue group or individual venue. The interface may include one or more images (e.g., image 401), text (e.g., text 402) or other display information. Further, the interface may also indicate whether the venue information being displayed is associated with a promoted item. For instance, the interface may display a promoted item indicator (e.g., indicator 403) to allow a user to discern between general location-based service items and promoted items.

FIG. 4B shows another promoted item type and associated interface elements according to various embodiments of the present invention. For instance, as shown in FIG. 4B, an interface 410 may be provided that is displayed within a display of a location-based service application. For example, the promoted item displayed may be a special, coupon, or offer that can be accepted by the user. For instance, a merchant may be permitted to create such an offer associated with a venue, chain or groups of venues. The interface may include one or more images (e.g., image 411), text (e.g., text 412) or other display information. Further, the interface may also indicate whether the special, offer or coupon being displayed is associated with a promoted item. For instance, the interface may display a promoted item indicator (e.g., indicator 413) to allow a user to discern between general location-based service items and a promoted item.

FIG. 4C shows another promoted item type and associated interface elements according to various embodiments of the present invention. For instance, as shown in FIG. 4C, an interface 420 may be provided that is displayed within a display of a location-based service application. For example, the promoted item displayed may be a credit card offer that can be accepted by the user. For instance, a merchant may be permitted to create such an offer associated with a venue, chain or groups of venues. The interface may include one or more images, text or other display information. Also, according to one embodiment, the offer may be sponsored by a particular credit card, which can be redeemed by using the credit card to perform the transaction. To this end, the interface may include an indicator (e.g., credit card indicator 422) to indicate which credit card type may be used to perform the transaction. Further, the interface may also indicate whether the credit card offer being displayed is associated with a promoted item. For instance, the interface may display a promoted item indicator (e.g., indicator 421) to allow a user to discern between general location-based service items and a promoted item.

In another embodiment, an interface may be provided (not shown) that displays promoted items after an action such as a check-in has been performed. For instance, according to one embodiment, such information may be displayed in a prominent location within the display in relation to the check-in information. Also, if a stream of activity of the user is displayed, the promoted item may be displayed in the stream of activity. In another embodiment, the location-based service may track (e.g., passively) a user's location and may display within the interface one or more promoted items. For instance, a location-based service process may operate as a background process and may display (e.g., in an interface of a mobile phone) promoted items as the user changes location. For example, a user may change location to a geographic area in which a promoted item (e.g., an advertisement) was defined. Movement of the user into that geographic area may cause the background process to trigger a display of the promoted item. Other display types are possible in association with promoted items of a location-based service and are within the spirit and scope of the present invention.

Further, the interface of the location-based application may include controls that allow users to interact with the promoted items. For instance, when a user selects a promoted item within the interface, they may be permitted to view additional details with the selected item. Further, the user may perform a “like” on a promoted special or broadcast that may cause the “liked” item to be added to the user's stream of activity (e.g., one that allows their friends to view their activity). Further, a user may dismiss a promotion which may cause that location-based service item not to be displayed to the user again.

According to another embodiment, a merchant-facing interface may be provided that permits a merchant to buying, creating, and reporting on promoted items within the location-based service. For instance, interfaces may be provided that allows a merchant to create and manage promotions on a location-based service. For instance, such an interface may permit a merchant to perform a number of functions relating to perform targeting, reporting and budgeting functions, among others.

For example, relating to the display of promotions, a location-based service may generate justifications within the interface for why a promotion appears based on where the user has been, what lists the user has saved, where their friends have been and created content, and where brands the user trusts have been and created content. According to one implementation, the location-based service may permit users “Like” promoted content within the results returned from the recommendation service, and merchants may be permitted to review such information. In another example, when a user clicks through on a promoted result from a venue that is part of a chain, the user may be permitted to view a map and list of other nearby locations from the chain.

In relation to targeting functions, the merchant may be permitted to create promotions with automatic geofence radiuses around a set of locations. For instance, the location-based service may permit advertisers target a group of pre-defined businesses with latitude/longitude information. In another example, the location-based service may permit advertisers promote businesses without having to define any keywords or demographic buckets within a search application by automatically matching keywords and types of users to those locations the advertiser wants to drive traffic to. In another implementation, creating a system to define an arbitrary set of “reactions” within a service—such as views, clicks, saves of a venue, likes of a venue, check-ins, etc. into a “conversion goal,” which may be a sequence of reactions that have to happen for an advertiser to pay. Also, in another implementation, advertisers may be permitted to bid on multiple conversion goals for the same campaign.

Regarding reporting, a merchant may be permitted to track views of a promotion that results in real-world foot traffic (e.g., as measured by a check-in) within a fixed window of time. Other reporting functions relating to promotions may be provided, such as impressions (e.g., views), conversions (e.g., responsive to actions taken such as a selection of a particular promotion item (e.g., broadcast, special, etc.), a “like” of a promotion item, or a save operation performed by the user on a particular venue.

Regarding budgeting functions, merchants may be permitted to perform budgeting activities and functions related to promoted items. For instance, the merchant-facing website may include a tool that predicts a tradeoff between time, cost, and impressions. In another example, an interface tool may be provided that, for a new (or existing) ad campaign, presents the merchant with a time period dropdown and a slider. As the slider moves, the interface displays an estimated cost and number of impressions that will be expected to occur if the ad is run for the time period selected in the drop down. In another example implementation, the location-based service may include a component that, using expected conversion rates and expected prices for conversions, can dynamically pace (e.g., start/stop) the serving of ads in to order to fit into a specified budget. It is appreciated that conversions in a location-based system can occur many hours or days after an impression is viewed.

Merchants may also be permitted to track “conversions” within the system. Table I below lists various conversion types that could be tracked within a location-based system, and various bid prices may be determined based on the format of the promoted item. For instance, the promoted item may be an offer associated with a credit card (a “load to card offer”) that when selected or redeemed, may cause a conversion event that can be tracked. In another example, the promoted item may be a pre-paid offer where the offer is purchased online by a user (e.g., a Groupon offer). The promoted item or action on a particular item may include specials, a “follow” or “like” action performed on an item, an action performed by a third party platform (e.g., a reservation made in the OpenTable reservation system), or other item or action relating to the item.

Table I shows various conversion possibilities associated with promoted items:

| Format of | | |
|---|---|---|
| Promoted | | “Bid price” per |
| Item | What would be a conversion | conversion |
| Load to | Options: | A number of options |
| card offer | When users load an offer | for “bid”: |
| | When users “redeem” | Cost per Load |
| | an offer by spending | Cost per Redeem |
| | over the offer threshold | Cost as a function of |
| | | redemption amount vs. |
| | | offer amount |
| Pre-paid | Purchase of a pre-paid deal | Bid = Deal value * 3^{rd} |
| deals | | party allocation* |
| | | location-based |
| | | service allocation |
| Free-form | Click then check-in within X hours | Bids for a generic |
| text/image | View then check-in within X hours | “conversion”, |
| content | Save to List (then check-in) | though this may be |
| | Call (then check-in) | segmented by type. |
| | Lookup directions (then check-in) | |
| Specials | Same as above, plus potentially | Same as above |
| with unlock | unlocking the special and | |
| rules | “redeeming” the special (e.g., | |
| | using a place to redeem button) | |
| “Follow” | A user elects to “follow” a | Bids for follows |
| venue/ | particular venue/brand/list | |
| brand/list | | |
| 3^{rd} party | Reserve on a reservation system | Bid = the flat |
| action | (e.g., the OpenTable system) | commission received |
| | Buy event tickets on a ticketing | from providers. |
| | website (e.g., the TicketMaster | |
| | system) | |
| | Order delivery from a provider | |
| | (e.g., Seamless) | |

It should be appreciated that other actions and item types may be used, and Table I is not exhaustive of all actions or item types.

Further, the location-based service may perform other actions to run more efficiently or otherwise improve the usability of the service. For instance, the location-based system may filter or suppress the display of promoted items received from of venues where a user has explicitly marked they are not interested in one of the venues in the context of recommendation results.

In another example implementation, the location-based system may use personal and social histories to influence what venues get retrieved for ranking, which results in a more relevant set of venues to rank. In yet another example implementation, the location-based service may only retrieve nearby promoted items (e.g., promoted items within a particular radius distance), resulting in better performance of a mobile location-based application and quality of the promotion (e.g., making the promotion more likely to be accepted/viewed/converted). Further, some promoted items may be limited (e.g., frequency-capped) by a particular venue or chain of venues.

Other improvements such as ranking may be performed and applied to promoted items to determine a displayed item for a particular user of the location-based service. For instance, a ranking component may be provided that provides more relevant promoted items, depending on the context. For instance, the ranking component may use the time of day when the user searches to bias toward businesses that are generally popular during that same time of the day. Also, the system may use historical actions of the user to influence what promotions may be displayed to the user. For instance, certain categories of promotions may be preferred based on the user's historical interest. The ranking component may also be configured to filter based on a calculated quality metric. For instance, the ranking component may cutoff certain promoted items if a predicted conversion rate is not above a particular threshold. Information gathered in real time related to defined promoted items (e.g., by the location-based service, a website, etc.) may be used to determine quality and performance.

Further, other improvements may be used in the display of promoted items that would be beneficial for usability. For instance, justifications for why a promotion appears based on where the user has been, what lists the user has saved, where their friends have been and created content, and where brands the user trusts have been and created content may be displayed to a user. In another example, an interface component may provided that allows a user to locate, by selecting a promoted item in the interface, a map and/or list of nearby locations of venues related to the promoted item.

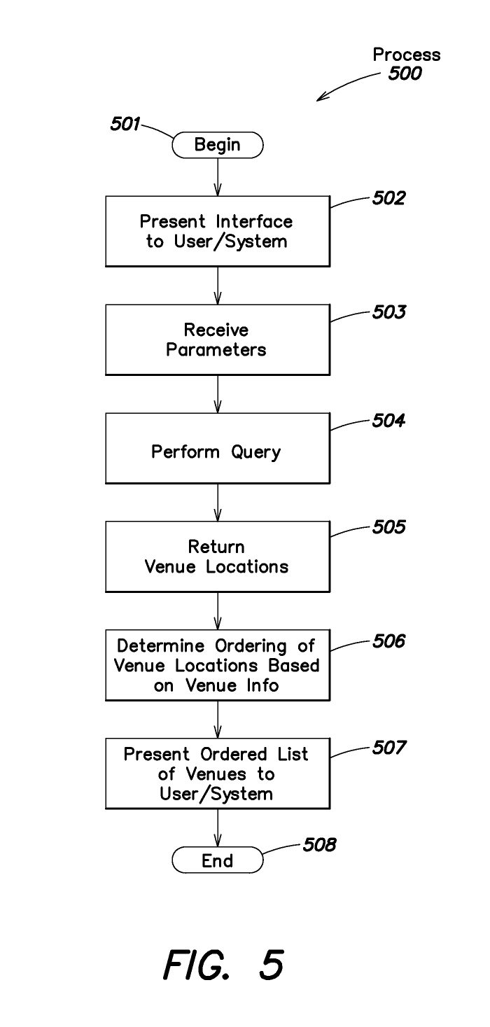

FIG. 5 shows an example process (e.g., process 500) for providing recommendations and/or promoted items in a location-based service in accordance with one embodiment. At block 501, process 500 begins. At block 502, a website, other application (e.g., a location-aware application executing on the mobile device) may be displayed to the user. Alternatively, an interface such as an API may be provided to an application for the purpose of providing recommendations and/or promoted items to another application or system.

At block 503, the location-based system may receive one or more parameters requesting a search for recommendations. Such information may be provided via one or more interfaces, such as receiving the parameters in an interface of a mobile device, the parameters being provided by a user within a search function performed on the mobile device. Also, the parameters may be received from a third party application or system that utilizes location-based services. Such parameters may include, for example, one or more keywords, distance, the current location of the user, one or more categories that limit the search results, an indication of what type of search performed (e.g. one based on user parameters, social network parameters, popularity within the overall location-based service, or combination of these types), among other parameters, either alone or in combination with other parameters.

At block 504, a component within the location-based service (e.g., a search engine such as search engine 211) may perform a search of stored venues matching some or all of the parameters provided. Such a search may be performed, for example, using venue information stored in database 207. At block 505, an output list or set of venue locations may be returned.

At block 506, a component within the location-based service (e.g., a scoring engine such as scoring engine 212) may determine an ordering of output venues that were provided by the query. In one embodiment, the ordering may be based on the venue information that is collected by the location-based service. As discussed, venue information that can be used to determine a ranking or order of venues may include user preference information, social network preference information, and/or popularity information. Scores may be computed for each venue, and ranking may be determined based on the computed scores. At block 507, an ordered list of venues may be provided to the user, application, other system, or other entity. At block 508, process 500 ends. In a similar manner, scores may be determined for promoted items, and such items may be displayed in addition to any recommendations provided. In one embodiment, promoted items having the highest score values may be promoted to the top of the displayed list of recommendations. In another embodiment, only a subset of recommendations are chosen for display, and a promoted item is selected from the subset of items. By using a redefined subset of items from which to promote a recommendation, performance of the promotion process is increased. Such concerns may be important in relation to a mobile application with limited resources, such as display size, bandwidth, processing capability or other resource.

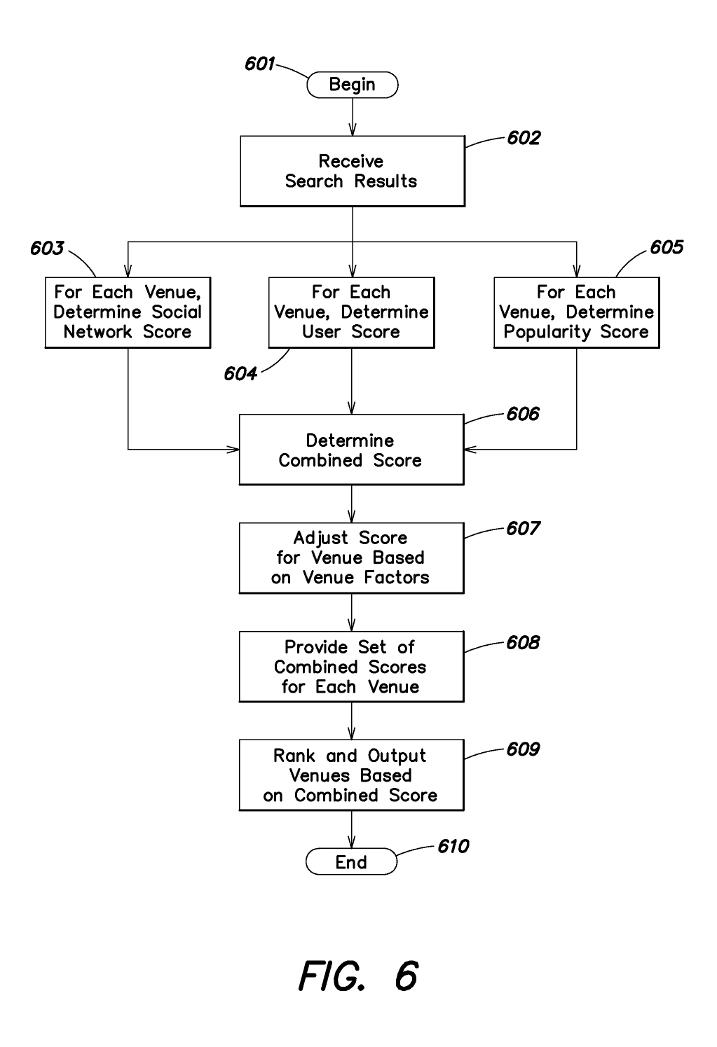

FIG. 6 shows an example process (e.g., process 600) for scoring venues in a location-based service in accordance with one embodiment. At block 601, process 600 begins. At block 602, a component of the location-based service (e.g., a scoring engine 212) receives search results which may include a set of venues defined in the location-based service. At block 604, for each venue within the result set, a user score may be determined based on user preferences as discussed above. In one embodiment, one or more functions such as collaborative filtering, user-user, k-nearest neighbor functions, or others may be used to determine a user score for a particular venue. In one embodiment, this function may be performed based on information stored by the location-based service indicating whether the user has previously been to this or similar venues. Further, this function may be performed based on information stored by the location-based service indicating that the user intends to go to this venue or similar venues.

At block 603, for each venue within the result set, a social network score may be determined based on social network preferences as discussed above. In one embodiment, one or more functions such as collaborative filtering, user-user, k-nearest neighbors functions, or others may be used to determine a social network score for a particular venue. In one embodiment, this function may be performed based on information stored by the location-based service indicating whether users within the specified user's social network has previously been to this or similar venues, and/or intends to go to this venue or similar venues.

At block 605, for each venue within the result set, a popularity score may be determined based on the popularity of the venue within the location-based service as discussed above. The popularity of the venue may be determined by the entire history of user preferences, some weighted function of preferences, a subset of particular users (e.g., users determined to be similar to the current user), or by other methods.

One or more of these scores may be used to determine a total score for a particular venue. In one embodiment, what scores that are used may be defined by the user within an interface of a mobile device application. In one embodiment, one or more scores are combined to determine a combined score for each venue within the result set. Optionally, the combined score for each venue may be adjusted based on one or more venue factors (e.g., at block 607). For instance, if the venue is not currently open at the time of day the search is executed, the score of that venue may be reduced so that the venue is not highly recommended. Further, if the venue location is currently popular or many people are checked-in to the venue, the score for that particular venue may be adjusted upward. According to one embodiment, different methods of scoring may be used alone or in combination to determine a combined score. At block 608, the set of combined scores for each venue may be provided as an output to a mobile device application, system or other entity. The receiving entity may then rank and output the venues based on the combined score at block 609. At block 610, process 600 ends.

According to one aspect, it is appreciated that higher quality venues are desired for presentation to users. According to one embodiment, one or more factors may be used alone or in combination with other factors to determine the quality of a particular venue. As discussed, it is desired that a signal indicative of the best venues would be helpful in the creation and display of a list to a user (e.g., particularly one of a location-based service that has limited display capability and/or needs to provide a limited number of recommendations). Thus, a method of ranking may be desired that provides a high-precision ranking of the “best” venues, but not necessarily a ranking of all venues, which might be typically returned in an Internet search.

In one embodiment, it is appreciated that a factor that is derived from a list of venues and how they are arranged may be used as an indicator of the level of quality of a particular venue. In one implementation of a location-based service, users are permitted to create “lists” of venues. For instance, in one implementation of a location-based service, a list of venues may be created by a particular user and shared with other users. Users may “follow” other users and/or lists, may have lists recommended to them based on their associations with other users, their venue history, or may have lists presented to them based on other criteria.

In one aspect, it is appreciated that higher quality venues are contained by more lists followed by more influential users and created by more influential users of the location-based service than “average” venues. Thus, in one implementation, a score may be determined, at least in part, based on the number of times that a particular venue appears within lists of these influential users. Because multiple lists may be used to determine a score, a single powerful list may not necessarily dominate the score.

According to one embodiment, a process may be performed to determine a score for a particular venue location based on a reputation score for a particular user. One example process includes the following:

Wherein the expression

rep(userᵢ)=reputation score for userᵢ

In one embodiment, a venue score (VenueListScore) may be determined according to the following:

```
VenueListScore =
      sum for each list Lᵢ that contains a venue:
            rep(author of Lᵢ) *
            sum for follower Fⱼ of list Lᵢ
                  cred(Fⱼ) / count(lists Fⱼ follows)
```

Where rep(author of Li) is a reputation score for the “author” or creator of the list of venues within the location-based service. The expression [cred(Fⱼ)/count(lists Fⱼ follows)] accounts for users who follow many lists. According to this expression, the credibility as calculated for a particular user is spread evenly over the lists that the user follows, so that an influential user that follows many lists may not dominate any one particular list.

According to another embodiment, it is appreciated that a factor that is derived from a measurement of how “expert” users view the venue may be used to determine the quality of that venue. In one implementation, there may be a ranking or scoring that is indicative of how popular a particular venue is with “expert” users within a particular venue category. For instance, do people who often go to coffee places (e.g., a coffee expert) go to this particular coffee place? In one implementation, expertise may be measured by a total activity in the category. For instance, a user's expertise in the category may be determined based on, for example, the number of check-ins, the number of venues checked into, tips left for venues in the category, photos taken, among other actions performed with respect to one or more venues in that category. Expertise may also be determined for a particular user based on geographic area or location.

In one embodiment, an “ExpertRank” function may be used by the location-based system to determine, for each user and category pair, how “expert” that user is in that category. For instance, in one implementation, the score may be determined as a linear combination of at least one or more of the following parameters:
a number of check-ins by the user in that category
a number of distinct venues checked into by the user that category
a number of tips left by the user in that category
a number of tips the user has “left” that other users have “done” in that category
   According to one implementation, these amounts may be weighted to determine an optimal score that reflects a user's expertise. Although the weights may be determined manually, it should be understood that the weights could be tuned (e.g., by a knowledge-based system) using a set of training examples of known users that are determined experts in certain categories.

Thus, in one example, there is one particular user that loves coffee, and has been to 40 distinct coffee places (venues), many of them the user has frequented dozens of times. Also, in the example, the user has left many tips, and many other users have completed these defined tips. Thus, that user may be given a high expertise score for the category “coffee” based on the interactions with the location-based service.

In another embodiment, it is appreciated that a factor that is derived from a user sentiment regarding certain venues in the location-based service may be used as an indication of the level of quality of a particular venue. For instance, the location-based service may analyze information left by users for a particular venue (e.g., “tips” left by users that describe the quality of the venue) to determine whether the sentiment relating to the venue is positive or negative. In one implementation, venues having more positive sentiment may be scored or ranked higher than those having negative sentiment.

In one embodiment, an “SentimentRank” function may be used by the location-based system to determine whether an overall sentiment about a venue is positive or negative (or other ranking or scoring factor type). According to one implementation, the function may be executed on “tips” or other feedback left by users for a particular venue. In the case of textual-based feedback, a keyword analysis may be used to determine whether the feedback is positive or negative. In one implementation, venues having a more positive score may be adjusted in the ranking, or their ranking or score may be adjusted. For example, a tip similar to “Best Mexican food in the city—I loved it!” is very positive, so that venue may be adjusted upward. A tip similar to “Terrible service, long lines.” is negative, so the ranking of the venue may be adjusted downward. A tip similar to “Slow, but very tasty” has mixed sentiment and may have a neutral or slightly higher or lower adjustment affect.

An overall score for the venue may be determined, in one embodiment, by determining a sum of the sentiment on all of the tips or other feedback left by users for the particular venue.

It is appreciated that in some location-based systems, some venues may have hundreds of tips, and therefore, this feedback may be highly indicative of the sentiment for a particular venue.

Sentiment or any of the above factors such as popularity may also be adjusted based on time. For instance, tips given two years ago may have less weight than a tip given more previously. In another example, scores may be adjusted based on the on time of day or day of week. In one implementation, one or more of the scores or rankings of a particular venue (e.g. venue popularity) may be based on historic check-ins in a particular defined period of time (e.g., performing a check-in within each hour of the week). Such tracking of scores in different time periods allows a location-based service to provide more granular time-based recommendations. For instance, a location-based service may determine that a particular venue may be most popular on Friday and Saturday nights after 10 pm. Other types of ranking or scores may be tracked in this manner. For example, check-in popularity, popularity with “friends” defined in a social network, popularity relative to a category, popularity relative to a neighborhood, may be determined based on time period according to various embodiments.

According to another aspect of the present invention, a location-based system may determine an adjustable boundary of a geographical area in which to search for venues based on a query (e.g., a query provided by a user within an interface of a mobile device). According to one embodiment, the boundary of search may be adjusted based on the density of venues within a particular area. For instance, from a particular geographic point, a radius from the geographic point may be adjusted to achieve a particular venue density within a circular area. Although a circle may be used, other boundary types and shapes may be used (e.g., square, rectangle, displayed map area, town, or similar boundary).

In another embodiment, the adjustable boundary may be determined based on a distance between subsequent “check-ins” in an area by users in that particular area in relation to some time. For instance, a determination may be made by the location-based system that a user checked in a certain distance from one check-in location point (e.g., a first venue) to a second check-in location point (e.g., a second venue). In one implementation, an average distance between check-in points (e.g., from one user, all users) may be used as an input to determine an adjustment of an adjustable boundary used for executing a search query for venue locations.

Such a search query may be time-dependent, in that the average distance may be computed for different time periods and the adjustable boundary may be modified according to the different periods. For instance, a search result returned by a location-based service based on a search for “pharmacies” at 3 AM may have a wider geographic search result than a similar search performed at 3 PM, if it is based on the number of check-in density and/or average distance between check-ins during the 3 AM period is much less than that at 3 PM. In a similar way, queries of areas having little check-in activity (and perhaps fewer venues defined) may use a wider geographic search.

According to another aspect, it is appreciated that the check-in history may be used as an indicator of the activity density within a particular region. In one implementation, check-in history may be used to determine a default or adjustable setting for performing a search query (e.g., as a setting in a location-based application operated by a user). In one embodiment, the boundary information may be used as a limiting parameter on a search query that is performed to limit a number of returned venues.

It should be appreciated that any of the above ranking/scoring methods may be used either alone or in combination with any other ranking and/or scoring methods.

### Example Interfaces

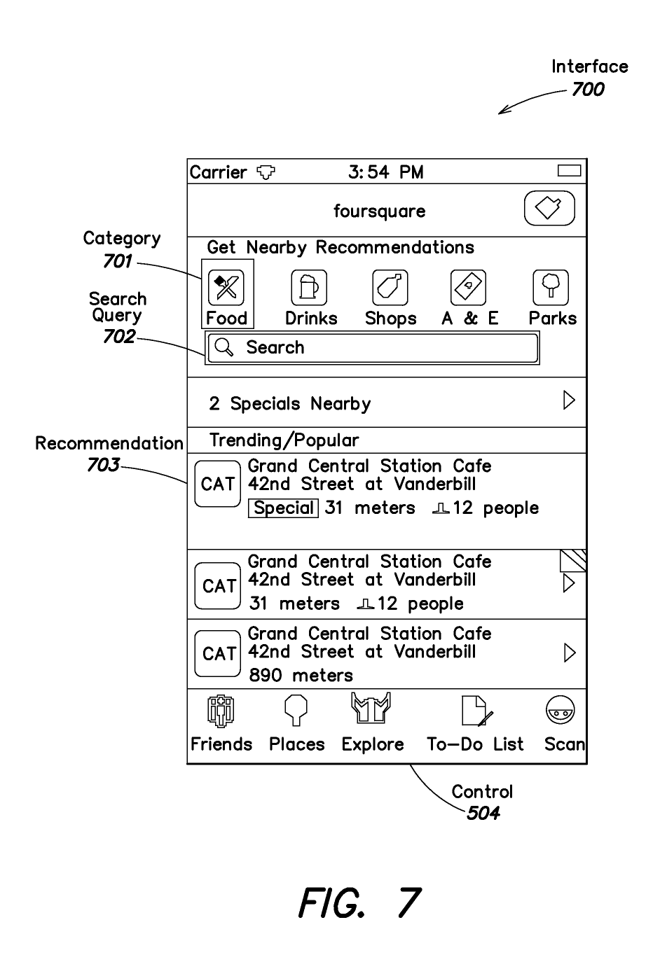

FIG. 7 shows one example interface in which recommendations may be provided according to one embodiment of the present invention. In particular, and interface 700 may be provided that shows one or more recommendations (e.g., recommendation 703) responsive to a user searching for one or more venues. In one embodiment, an “Explore” control (e.g., control 704) is presented within an interface of the location-based system (e.g., an interface of a mobile device) that allows the user to search and view recommendations for particular venues.

In one embodiment, interface 700 may include one or more categories (e.g., category 701) that may permit the user to identify venues associated with these categories. For instance, example categories may include food, drinks, shops, art and entertainment (A&E), parks, among other possible categories that may be defined based on venues.

According to one embodiment, interface 700 may include a search query area 702 where users may enter text based search queries. Further, interface 700 may include a control, when activated, executes a search of venues according to various embodiments as discussed above. In another embodiment, a search query is executed as information is entered and/or changed by the user. Such a search query may be responsive to one or more controls or one or more query inputs to limit a number of returned venues.

Responsive to users selecting one or more categories and/or entering information within search query area 702, one or more recommendations may be shown to the user within a recommendation area within the display. In one embodiment, interface 700 may include a “trending” area that shows venues where check-in activity is increasing. As discussed above, one or more recommendations may be ranked and/or scored using the various methods described above, either alone or in combination, and the recommendations may be arranged within the interface (interface 700) responsive to these determined ranks or scores.

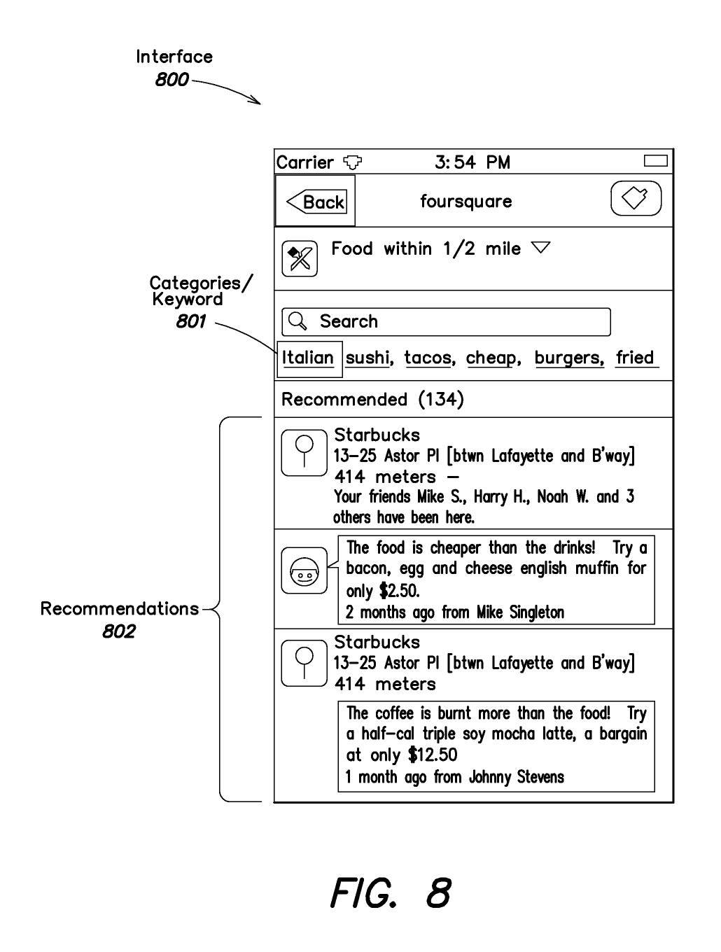

FIG. 8 shows an example interface within a particular venue category according to one embodiment of the present invention. In particular, interface 800 may be displayed to a user, for instance, after the user selects one or more categories (e.g. food). Interface 800 may include further categories/keywords (e.g. categories/keywords 801) that permits the user to further narrow the category of venues to be searched. In one embodiment, such categories or keywords may be extracted from information defined within the venues defined within the location-based service. Such information may include, for example, descriptions of the venues, any feedback (e.g., tips) for the venue, any tags or other defining information for the venue. Such categories/keywords that may be used to narrow the search may change based on popularity, location, frequency of search and/or any other parameter that permits the user to find the necessary venues.

Interface 800 may also include a recommendations area 802 wherein various recommendations are displayed corresponding to search criteria, location of the user, personal information of the user, social relations of the user, popularity, among other criteria. According to one embodiment of the present invention, within each of the recommendations provided to the user, a justification (e.g., justification 803) may be displayed that indicates to the user why a particular recommendation was provided. For instance in the example shown, a suitable justification may include “Your friend Mike S, Harry H, Noah W, and three others have been here.” Therefore, rather than merely providing search results, the location-based system may provide additional information regarding the recommendation that might trigger a user to adopt the recommendation. For instance, if the user perceives that Mike S. has similar tastes, the user may be inclined to review and/or adopt the recommendation.

Further, in one embodiment, interface 800 may include an area where a tip is displayed (e.g., tip area 804). One or more tip information may be chosen by the location-based system to be displayed to the user. This information may be chosen, for instance, based on a social relationship between the user and the user whose tip information is being displayed within the recommendation interface.

### Example Computer Implementations

Processes described above are merely illustrative embodiments of systems that may provide recommendations and/or promoted items in association with a location-based service. Such illustrative embodiments are not intended to limit the scope of the present invention, as any of numerous other implementations for performing the invention. None of the claims set forth below are intended to be limited to any particular implementation of a method of providing player incentives, unless such claim includes a limitation explicitly reciting a particular implementation.

Processes and methods associated with various embodiments, acts thereof and various embodiments and variations of these methods and acts, individually or in combination, may be defined by computer-readable signals tangibly embodied on a computer-readable medium, for example, a non-volatile recording medium, an integrated circuit memory element, or a combination thereof. According to one embodiment, the computer-readable medium may be non-transitory in that the computer-executable instructions may be stored permanently or semi-permanently on the medium. Such signals may define instructions, for example, as part of one or more programs, that, as a result of being executed by a computer, instruct the computer to perform one or more of the methods or acts described herein, and/or various embodiments, to variations and combinations thereof. Such instructions may be written in any of a plurality of programming languages, for example, Java, Visual Basic, C, C#, or C++, Fortran, Pascal, Eiffel, Basic, COBOL, etc., or any of a variety of combinations thereof. The computer-readable medium on which such instructions are stored may reside on one or more of the components of a general-purpose computer described above, and may be distributed across one or more of such components.

The computer-readable medium may be transportable such that the instructions stored thereon can be loaded onto any computer system resource to implement the aspects of the present invention discussed herein. In addition, it should be appreciated that the instructions stored on the computer-readable medium, described above, are not limited to instructions embodied as part of an application program running on a host computer. Rather, the instructions may be embodied as any type of computer code (e.g., software or microcode) that can be employed to program a processor to implement the above-discussed aspects of the present invention.

Various embodiments according to the invention may be implemented on one or more computer systems. These computer systems may be, for example, general-purpose computers such as those based on Intel PENTIUM-type processor, Motorola PowerPC, Sun UltraSPARC, Hewlett-Packard PA-RISC processors, ARM Cortex processor, Qualcomm Scorpion processor, or any other type of processor. It should be appreciated that one or more of any type computer system may be used to partially or fully automate play of the described game according to various embodiments of the invention. Further, the software design system may be located on a single computer or may be distributed among a plurality of computers attached by a communications network.

The computer system may include specially-programmed, special-purpose hardware, for example, an application-specific integrated circuit (ASIC). Aspects of the invention may be implemented in software, hardware or firmware, or any combination thereof. Further, such methods, acts, systems, system elements and components thereof may be implemented as part of the present invention.

One or more portions of the computer system may be distributed across one or more computer systems coupled to a communications network. These computer systems also may be general-purpose computer systems. For example, various aspects of the invention may be distributed among one or more computer systems configured to provide a service (e.g., servers) to one or more client computers, or to perform an overall task as part of a distributed system. For example, various aspects of the invention may be performed on a client-server system that includes components distributed among one or more server systems that perform various functions according to various embodiments of the invention. These components may be executable, intermediate (e.g., IL) or interpreted (e.g., Java) code which communicate over a communication network (e.g., the Internet) using a communication protocol (e.g., TCP/IP).

It should be appreciated that the invention is not limited to executing on any particular system or group of systems. Also, it should be appreciated that the invention is not limited to any particular distributed architecture, network, or communication protocol.

Various embodiments of the present invention may be programmed using an object-oriented programming language, such as SmallTalk, Java, C++, Ada, or C# (C-Sharp). Other object-oriented programming languages may also be used. Alternatively, functional, scripting, and/or logical programming languages may be used. Various aspects of the invention may be implemented in a non-programmed environment (e.g., documents created in HTML, XML or other format that, when viewed in a window of a browser program, render aspects of a graphical-user interface (GUI) or perform other functions). Various aspects of the invention may be implemented as programmed or non-programmed elements, or any combination thereof.

Further, on each of the one or more computer systems that include one or more components of distributed system 200, each of the components may reside in one or more locations on the system. For example, different portions of the components of system 200 may reside in different areas of memory (e.g., RAM, ROM, disk, etc.) on one or more computer systems. Each of such one or more computer systems may include, among other components, a plurality of known components such as one or more processors, a memory system, a disk storage system, one or more network interfaces, and one or more busses or other internal communication links interconnecting the various components.

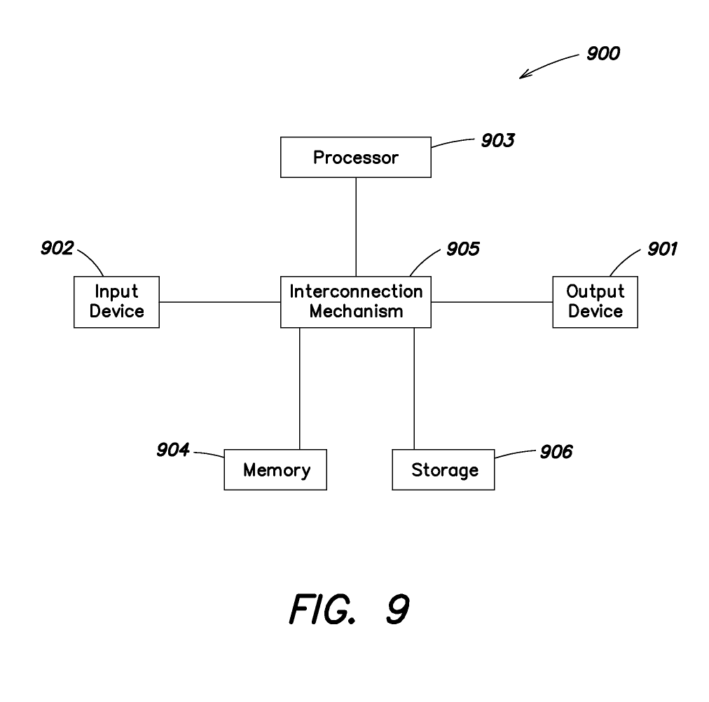

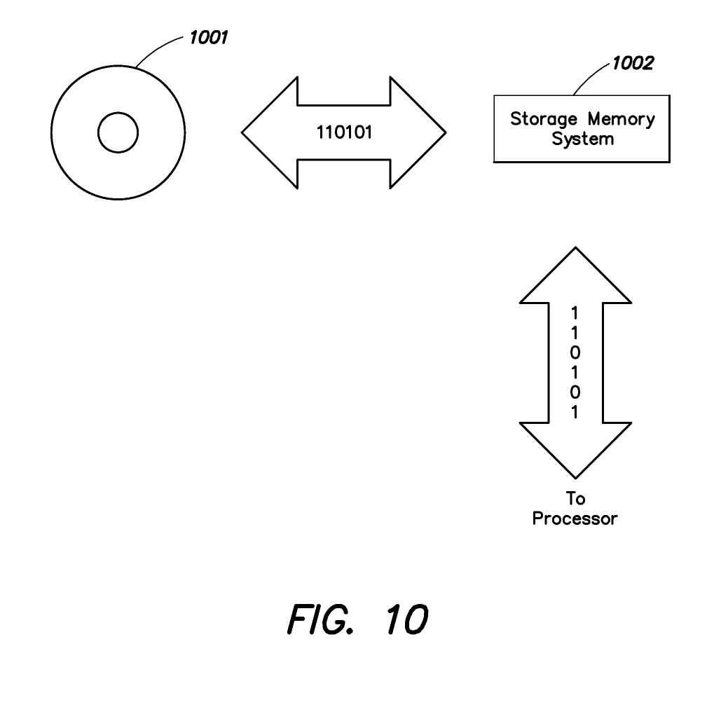

Any number of systems of distributed system 200 may be implemented on a computer system described below in relation to FIGS. 9 and 10. In particular, FIG. 9 shows an example computer system 900 used to implement various aspects. FIG. 10 shows an example storage system that may be used.

System 900 is merely an illustrative embodiment of a computer system suitable for implementing various aspects of the invention. Such an illustrative embodiment is not intended to limit the scope of the invention, as any of numerous other implementations of the system, for example, are possible and are intended to fall within the scope of the invention. For example, a virtual computing platform may be used. None of the claims set forth below are intended to be limited to any particular implementation of the system unless such claim includes a limitation explicitly reciting a particular implementation.

Various embodiments according to the invention may be implemented on one or more computer systems. These computer systems may be, for example, general-purpose computers such as those based on Intel PENTIUM-type processor, Motorola PowerPC, Sun UltraSPARC, Hewlett-Packard PA-RISC processors, or any other type of processor. It should be appreciated that one or more of any type computer system may be used to partially or fully automate integration of the location-based services with the other systems and services according to various embodiments of the invention. Further, the software design system may be located on a single computer or may be distributed among a plurality of computers attached by a communications network.

For example, various aspects of the invention may be implemented as specialized software executing in a general-purpose computer system 900 such as that shown in FIG. 9. The computer system 900 may include a processor 903 connected to one or more memory devices 904, such as a disk drive, memory, or other device for storing data. Memory 904 is typically used for storing programs and data during operation of the computer system 900. Components of computer system 900 may be coupled by an interconnection mechanism 905, which may include one or more busses (e.g., between components that are integrated within a same machine) and/or a network (e.g., between components that reside on separate discrete machines). The interconnection mechanism 905 enables communications (e.g., data, instructions) to be exchanged between system components of system 900. Computer system 900 also includes one or more input devices 902, for example, a keyboard, mouse, trackball, microphone, touch screen, and one or more output devices 901, for example, a printing device, display screen, and/or speaker. In addition, computer system 900 may contain one or more interfaces (not shown) that connect computer system 900 to a communication network (in addition or as an alternative to the interconnection mechanism 905.

The storage system 906, shown in greater detail in FIG. 10, typically includes a computer readable and writeable nonvolatile recording medium 1001 in which signals are stored that define a program to be executed by the processor or information stored on or in the medium 1001 to be processed by the program. The medium may, for example, be a disk or flash memory. Typically, in operation, the processor causes data to be read from the nonvolatile recording medium 1001 into another memory 1002 that allows for faster access to the information by the processor than does the medium 1001. This memory 1002 is typically a volatile, random access memory such as a dynamic random access memory (DRAM) or static memory (SRAM). It may be located in storage system 906, as shown, or in memory system 904, not shown. The processor 903 generally manipulates the data within the integrated circuit memory 904, 1002 and then copies the data to the medium 1001 after processing is completed. A variety of mechanisms are known for managing data movement between the medium 1001 and the integrated circuit memory element 904, 1002, and the invention is not limited thereto. The invention is not limited to a particular memory system 904 or storage system 906.

The computer system may include specially-programmed, special-purpose hardware, for example, an application-specific integrated circuit (ASIC). Aspects of the invention may be implemented in software, hardware or firmware, or any combination thereof. Further, such methods, acts, systems, system elements and components thereof may be implemented as part of the computer system described above or as an independent component.

Although computer system 900 is shown by way of example as one type of computer system upon which various aspects of the invention may be practiced, it should be appreciated that aspects of the invention are not limited to being implemented on the computer system as shown in FIG. 9. Various aspects of the invention may be practiced on one or more computers having a different architecture or components that that shown in FIG. 9.

Computer system 900 may be a general-purpose computer system that is programmable using a high-level computer programming language. Computer system 900 may be also implemented using specially programmed, special purpose hardware. In computer system 900, processor 903 is typically a commercially available processor such as the well-known Pentium, Pentium, Core, Core Vpro, Xeon, or Itanium class processors available from the Intel Corporation. Many other processors are available. Such a processor usually executes an operating system which may be, for example, the Windows NT, Windows 2000 (Windows ME), Windows XP, Windows Vista or Windows 7 or 8 operating systems available from the Microsoft Corporation, MAC OS X Snow Leopard, MAC OS X Lion operating systems available from Apple Computer, the Solaris Operating System available from Sun Microsystems, iOS Blackberry OS, Windows 7 Mobile or Android OS operating system or to UNIX available from various sources. Many other operating systems may be used.

The processor and operating system together define a computer platform for which application programs in high-level programming languages are written. It should be understood that the invention is not limited to a particular computer system platform, processor, operating system, or network. Also, it should be apparent to those skilled in the art that the present invention is not limited to a specific programming language or computer system. Further, it should be appreciated that other appropriate programming languages and other appropriate computer systems could also be used.

One or more portions of the computer system may be distributed across one or more computer systems (not shown) coupled to a communications network. These computer systems also may be general-purpose computer systems. For example, various aspects of the invention may be distributed among one or more computer systems configured to provide a service (e.g., servers) to one or more client computers, or to perform an overall task as part of a distributed system. For example, various aspects of the invention may be performed on a client-server system that includes components distributed among one or more server systems that perform various functions according to various embodiments of the invention. These components may be executable, intermediate (e.g., IL) or interpreted (e.g., Java) code which communicate over a communication network (e.g., the Internet) using a communication protocol (e.g., TCP/IP).

It should be appreciated that the invention is not limited to executing on any particular system or group of systems. Also, it should be appreciated that the invention is not limited to any particular distributed architecture, network, or communication protocol.

Various embodiments of the present invention may be programmed using an object-oriented programming language, such as SmallTalk, Java, C++, Ada, or C# (C-Sharp). Other object-oriented programming languages may also be used. Alternatively, functional, scripting, and/or logical programming languages may be used. Various aspects of the invention may be implemented in a non-programmed environment (e.g., documents created in HTML, XML or other format that, when viewed in a window of a browser program, render aspects of a graphical-user interface (GUI) or perform other functions). Various aspects of the invention may be implemented using various Internet technologies and other programming methods. Further, various aspects of the present invention may be implemented in a cloud-based computing platform, such as the well-known EC2 platform available commercially from Amazon.com, Seattle, Wash., among others. Various aspects of the invention may be implemented as programmed or non-programmed elements, or any combination thereof.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A method for presenting information to a user by a location-based system, the method comprising acts of:
displaying, on a mobile device, a plurality of search categories for locating one or more of a plurality of venues;
accepting a user selection of at least one of the plurality of search categories;
determining a ranking of at least a portion of the plurality of venues for display in a display of the mobile device, the display being associated with the user selected search category;
displaying the ranking of the at least a portion of the plurality of venues in the display;
creating at least one promoted item associated with at least one of the plurality of venues; and
displaying in the display of the mobile device the at least one promoted item within the ranking of the at least a portion of the plurality of venues in the display.

2. The method according to claim 1, wherein the act of displaying in the display of the mobile device the at least one promoted item includes displaying the at least one promoted item at a top of a ranked list of the at least a portion of the plurality of venues.

3. The method according to claim 1, wherein the act of displaying in the display of the mobile device the at least one promoted item includes displaying the at least one promoted item only within a particular designated category.

4. The method according to claim 1, wherein the act of displaying in the display of the mobile device the at least one promoted item includes an act of displaying the at least one promoted item responsive to location of a mobile device in relation to a location of the at least one promoted item.

5. The method according to claim 1, wherein the at least one promoted item includes a venue defined within the location-based system.

6. The method according to claim 1, wherein the act of determining a ranking of the at least a portion of the plurality of venues for display in a display of the mobile device is responsive to an act of determining a location of the mobile device in relation to the respective locations of the at least a portion of the plurality of venues.

7. The method according to claim 6, wherein the act of determining a ranking of one of the at least a portion of the plurality of venues is based on a distance of the mobile device to the one of the at least a portion of the plurality of venues.

8. The method according to claim 1, wherein the location-based system accepts at least one bid on a placement of the at least one promoted item from a venue operator associated with a venue of the at least one promoted item.

9. A system for presenting information to a user by a location-based system, the system comprising:
a display, the display being adapted to display a plurality of search categories for locating one or more of a plurality of venues;
an interface defined within the display configured to accept a user selection of at least one of the plurality of search categories;
a processor that is adapted to determine a ranking of at least a portion of the plurality of venues for display in the display, the display being associated with the user selected search category, wherein the display is adapted to display the ranking of the at least a portion of the plurality of venues; and
an interface configured to create at least one promoted item associated with at least one of the plurality of venues, wherein the display is configured to display the at least one promoted item within the ranking of the at least a portion of the plurality of venues.

10. The system according to claim 9, wherein the display is configured to display the at least one promoted item at a top of a ranked list of the at least a portion of the plurality of venues.

11. The system according to claim 9, wherein the display is configured to display the at least one promoted item only within a particular designated category.

12. The system according to claim 9, wherein the display is configured to display the at least one promoted item responsive to location of a mobile device in relation to a location of the at least one promoted item.

13. The system according to claim 9, wherein the at least one promoted item includes a venue defined within the location-based system.

14. The system according to claim 9, wherein the processor that is adapted to determine the ranking of the at least a portion of the plurality of venues for display in the display is responsive to a component that is adapted to determine a location of the mobile device in relation to the respective locations of the at least a portion of the plurality of venues.

15. The system according to claim 14, wherein the processor that is adapted to determine the ranking of the at least a portion of the plurality of venues for display in the display is responsive to a distance of the mobile device to the one of the at least a portion of the plurality of venues.

16. The system according to claim 9, wherein the location-based system accepts at least one bid on a placement of the at least one promoted item from a venue operator associated with a venue of the at least one promoted item.

17. A method for processing venue information in a location-based system, the method comprising acts of:
creating, by an advertiser, an item to be promoted in a list of recommended venues;
storing the item to be promoted in a location-based system;
determining one or more user-related parameters;
scoring a plurality of venues based the determined one or more user-related parameters;
determining a list of recommended venues to display; and
displaying the list of recommended venues to display including the promoted item.

18. The method according to claim 17, wherein the one or more user-related parameters includes a determined location of the user.

19. The method according to claim 17, wherein the act of displaying the list of recommended venues to display including the promoted item includes displaying the promoted item at a top of a ranked list of the list of recommended venues.

20. The method according to claim 17, wherein the act of displaying the list of recommended venues to display including the promoted item includes displaying the promoted item only within a particular designated category.

21. The method according to claim 17, wherein the act of scoring the plurality of venues based the determined one or more user-related parameters is responsive to a location of a mobile device in relation to a location of the at least one promoted item.

22. The method according to claim 17, wherein the promoted item includes a venue defined within the location-based system.

23. The method according to claim 17, wherein the act of displaying the list of recommended venues to display including the promoted item is responsive to an act of determining a location of a mobile device in relation to the respective locations of the at least a portion of the plurality of venues.

24. The method according to claim 23, further comprising an act of determining a ranking of one of the at least a portion of the plurality of venues based on a distance of the mobile device to the one of the at least a portion of the plurality of venues.

25. The method according to claim 17, further comprising an act of accepting at least one bid on a placement of the promoted item from a venue operator associated with a venue of the promoted item.

26. The method according to claim 1, wherein the promoted item is at least one of a group comprising:
a venue;
an advertisement;
a special;
an offer;
a message; and
a location-based service item.

27. The method according to claim 17, wherein the promoted item is at least one of a group comprising:
a venue;
an advertisement;
a special;
an offer;
a message; and
a location-based service item.

28. A method for processing venue information in a location-based system, the method comprising acts of:
creating, by an advertiser, an item to be promoted in a list of recommended venues;
storing the item to be promoted in a location-based system;
determining activity of a user in relation to the location-based system; and
displaying the promoted item to the user responsive to the determined activity.

29. The method according to claim 28, wherein the act of determining activity of a user further comprises an act of determining a location of the user, and responsive to the determined location of the user, performing the act of displaying the promoted item to the user.

30. The method according to claim 29, further comprising an act of associating, with the item to be promoted, a geographic location, and wherein the act of displaying the promoted item to the user is responsive to an act of determining if the user is located at or near the geographic location.
